(19) United States
(12) Patent Application Publication
(10) Pub. No.: US 2025/0103598 A1
(43) Pub. Date: Mar. 27, 2025

(54) METHODS AND SYSTEMS FOR AUTOMATED SUSTAINABILITY AND MANAGEMENT OF A CLOUD INFRASTRUCTURE

(71) Applicant: VMware LLC, Palo Alto, CA (US)

(72) Inventors: Arnak Poghosyan, Yerevan (AM); Ashot Harutyunyan, Yerevan (AM); Tigran Bunarjyan, Yerevan (AM); Garik Gyulasaryan, Yerevan (AM); Vlad Harutyunyan, Yerevan (AM); Artak Mehrabyan, Yerevan (AM); Marine Ghandevosyan, Yerevam (AM)

(73) Assignee: VMware LLC, Palo Alto, CA (US)

(21) Appl. No.: 18/373,018

(22) Filed: Sep. 26, 2023

(51) Int. Cl. G06F 16/2455; G06F 16/23

(52) U.S. Cl. CPC G06F 16/24564; G06F 16/2322

(57) ABSTRACT

Automated computer-implemented methods and systems for automated detection and termination of idle objects executing in a cloud infrastructure. The methods and systems learn rules from previous instances in which the object was terminated based on log messages associated with the previous instances. The rules are used to perform real time detection of idle instances of the object and, in response, terminate the object.

### TECHNICAL FIELD

This disclosure is directed to sustainability of a cloud infrastructure.

### BACKGROUND

Electronic computing has evolved from primitive, vacuum-tube-based computer systems, initially developed during the 1940s, to modern electronic computing systems with large numbers of multi-processor computer systems, such as server computers and workstations, are networked together with large-capacity data-storage devices to produce geographically distributed computing systems that provide enormous computational bandwidths and data-storage capacities. These large, distributed computing systems include data centers and are made possible by advancements in virtualization, computer networking, distributed operating systems and applications, data-storage appliances, computer hardware, and software technologies. The data center hardware, virtualization, abstracted resources, data storage, and network resources combined form a cloud infrastructure that is used by organizations, such as governments and ecommerce businesses, to run applications that provide business services, web services, streaming services, and other cloud services to millions of users each day.

Advancements in virtualization, networking, and other distributed computing technologies have paved the way for scaling of applications in response to user demand. The applications can be monolithic applications or distributed applications. A typical monolithic application is single-tiered software in which the user interface, application programming interfaces, data processing, and data access code are implemented in a single program that is run on a single platform, such as a virtual machine (“VM”) or in a container also called an object. As demand increases, the number of monolithic applications deployed in a cloud infrastructure is scaled up accordingly. Alternatively, distributed applications can be run with independent application components, called microservices. Each microservice has its own logic and database and performs a single function or provides a single service and is deployed in a virtual object. Separate microservices are executed in VMs or containers and are scaled up to meet increasing demand for services. A typical cloud infrastructure runs tens of thousands of applications each with numerous microservices executed in objects that can be scaled up to meet increasing demands for services.

Although objects have enabled applications to be scaled to meet increasing demand for services, many objects that are not terminated become idle objects when the demand for services decreases. Other objects may become idle because of a recent update that creates a programming bug, while other objects may not have been updated to be compatible with other objects or software. Whatever the cause, idle objects that do not actively perform associated services are problematic for efficient and sustainable operation of a cloud infrastructure because idle objects continue to consume energy, CPU, memory, networking, and storage resources. For example, an ecommerce application scales up objects that run shipping, inventory, and banking microservices to accommodate an increase in the number of customers to the ecommerce website during a high-volume sales event, such as a holiday or a limited sale. However, when the sales event is over a number of these objects are not terminated and become idle. In other words, many of the idle objects that previously executed shipping, inventory, and banking microservices are no longer actively performing these services, but these objects continue to consume energy, CPU, memory, networking, and storage resources of the cloud infrastructure. Resources used by idle objects are considered wasted because the resources are not reused for other services. Moreover, undetected idle objects increase cost of operations for application owners by continuing to pay for use of the wasted resources. Therefore, detecting wasted resources and terminating idle objects is a critical sustainability issue.

The usage of resources is not transparent for systems administrators of a cloud infrastructure and application owners. Cloud service providers often employ site reliability engineering teams of experts to create and deploy automated script programs for identifying and removing idle objects. However, script maintenance is complicated and requires key engineers to be involved. Cloud native products can change drastically, and new case scenarios arise often, but most scripts apply static rules to determine idle objects. As a result, these script programs require continuous hands on updating to account for the myriad of different objects created for evolving changes to applications and microservices. Detection of idle objects is an expensive and often inaccurate ongoing sustainability issue for cloud infrastructures and application owners. Systems administrators and application owners seek automated methods and systems that detect and terminate idle objects to free up wasted resources so that resources can be assigned to other services and reduce the costs to application owners.

### SUMMARY

Automated computer-implemented methods and systems for detection and termination of idle objects executing in a cloud infrastructure. In one aspect, the methods retrieve log messages that are stored in a log file of the object and correspond to previous time intervals in which the object was idle and terminated. Rules are trained rules to detect idle instances of the object based on frequencies of event types of log messages that correspond to the previous terminated instances of the object. The methods also incorporate domain expert knowledge to refine and enrich the rules by displaying a graphical user interface that enables the domain experts to verify and change conditions of the rules. The rules and conditions are subsequently stored in a rules database. The object is automatically terminated in response to frequencies of event types of log messages recorded in a current time interval that satisfy conditions of one of the rules stored in the rules database.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machines (“VMs”) and VM execution environments.

FIG. 6 shows an example of an open virtualization format package.

FIG. 7 shows examples of virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a cloud infrastructure.

FIG. 14 shows an example of logging log messages in log files.

FIG. 15 shows an example source code of an event source.

FIG. 16 shows an example of a log write instruction.

FIG. 17 shows an example of a log message generated by the log write instruction in FIG. 16.

FIG. 18 shows a small, eight-entry portion of a log file.

FIG. 19A shown a table of examples of regular expressions designed to match particular character strings of log messages.

FIG. 19B shows a table of examples of primary Grok patterns and corresponding regular expressions.

FIG. 19C shows an example of a Grok expression used to extract tokens from a log message.

FIG. 20 shows construction of example frequency distribution from log messages of an object produced in a time interval when the object was idle.

FIG. 21 shows an example data frame 2102 obtained for R separate termination instances of the object and an example data frame 2104 obtained for Q separate alive instances of the object.

FIG. 22 shows an example rule learning engine used to generate rules for frequencies of common event types of the object.

FIG. 23 shows an example graphical user interface that enables a domain expert to view and validate rules for detecting idle instances and alive instances of an object running in a cloud infrastructure.

FIG. 24 is a flow diagram of a method for detecting and terminating an idle object executing in a cloud infrastructure.

### DETAILED DESCRIPTION

This disclosure presents automated computer-implemented methods and systems for automated detection and termination of idle objects executing in a cloud infrastructure. Computer hardware, complex computational systems, and virtualization are described are described in a first subsection. Computer-implemented methods and systems for automated detection and termination of idle objects executing in a cloud infrastructure are described below in a second subsection.

### Computer Hardware, Complex Computational Systems, and Virtualization

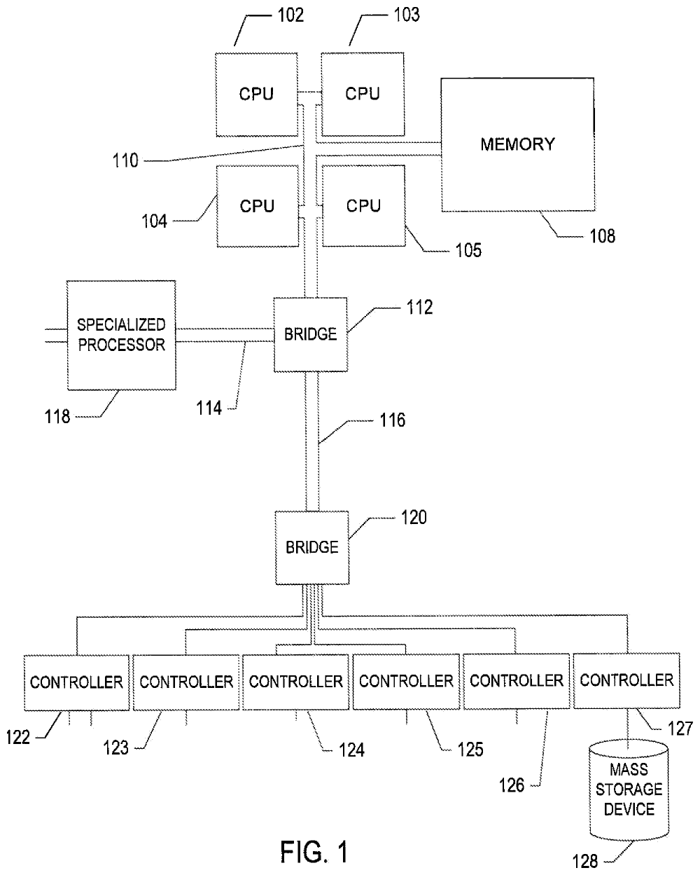

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

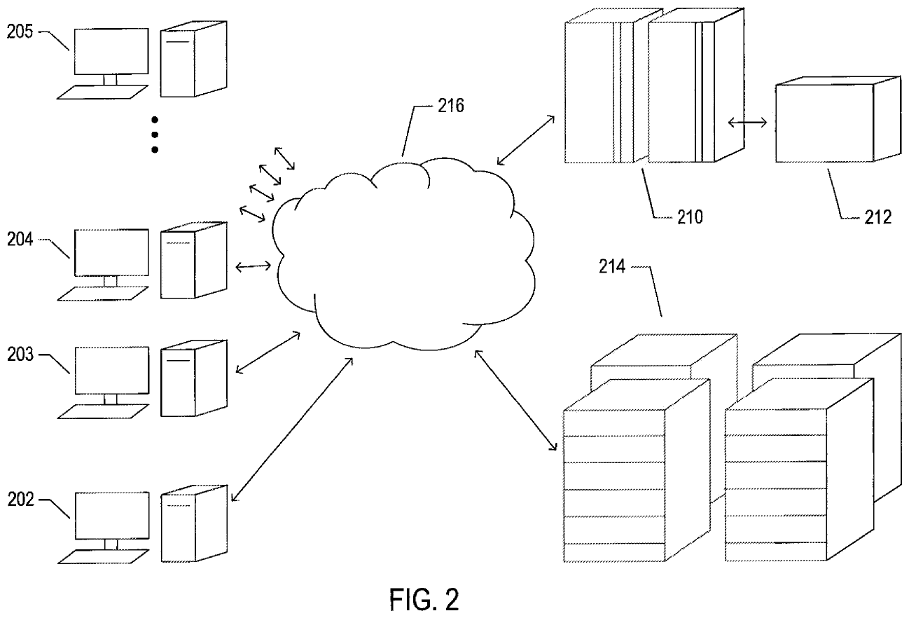

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

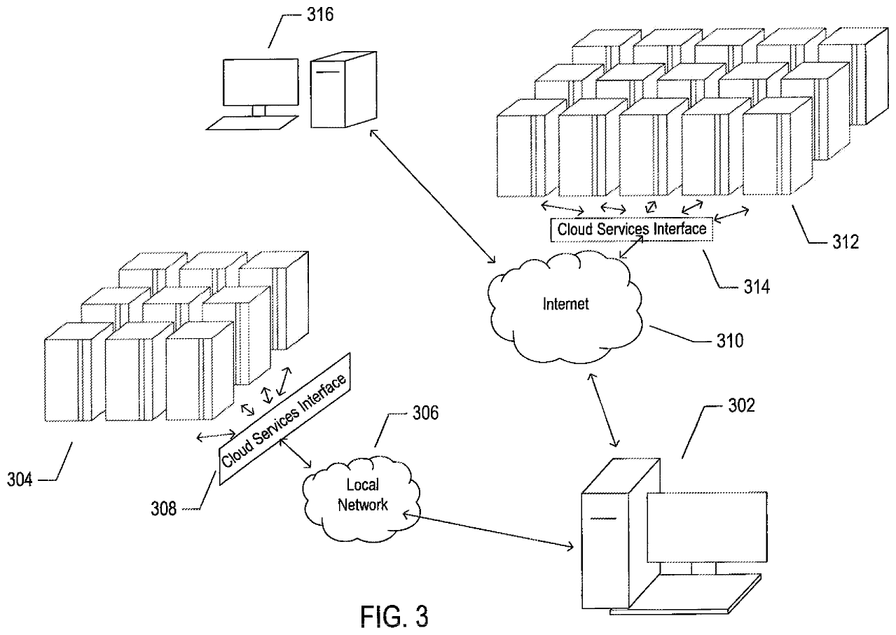

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

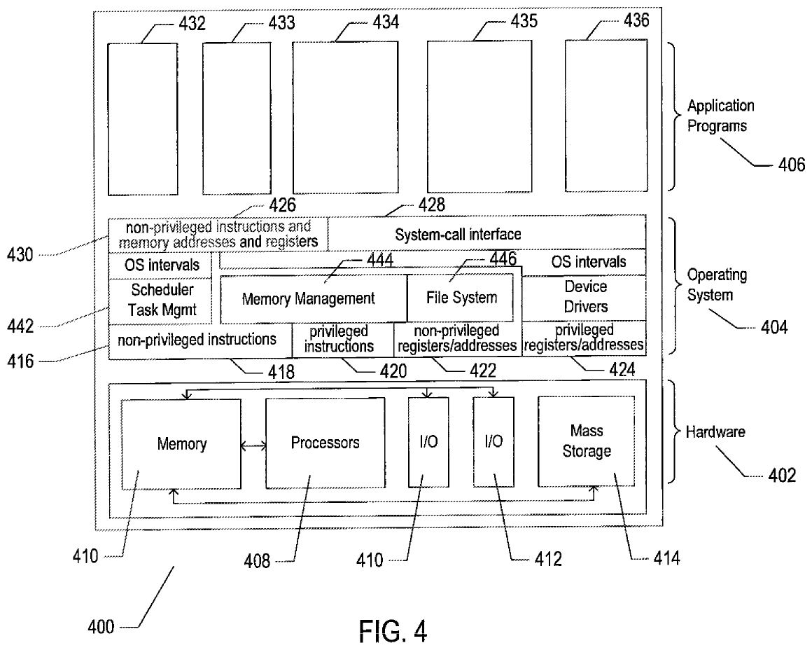

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

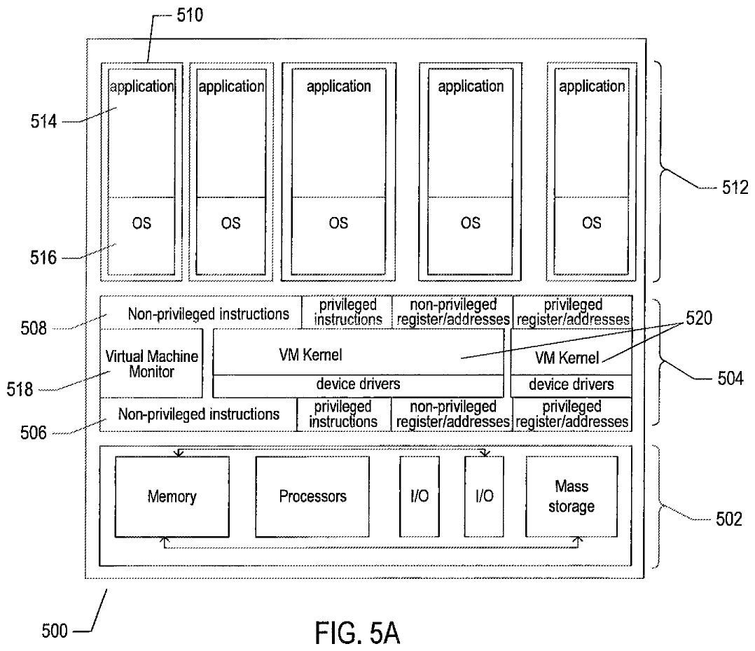

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

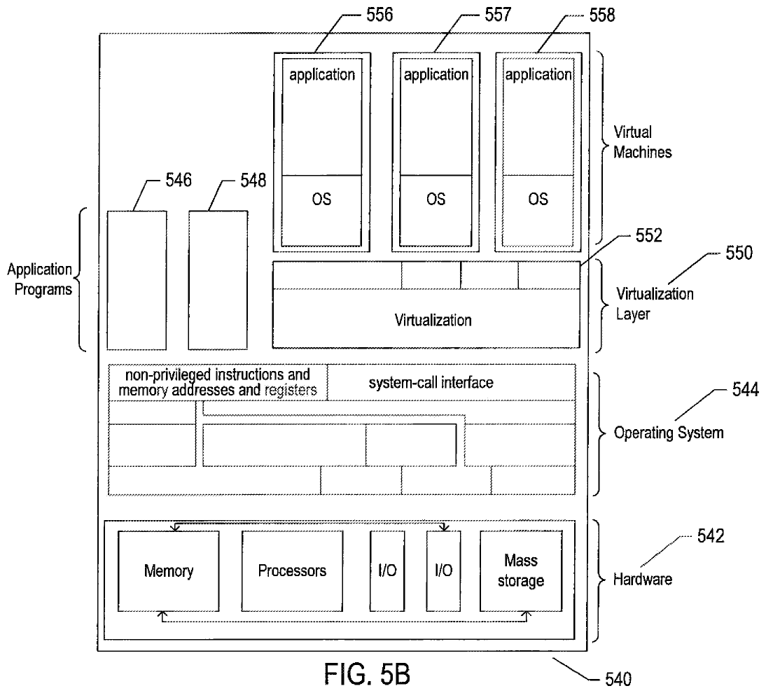

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

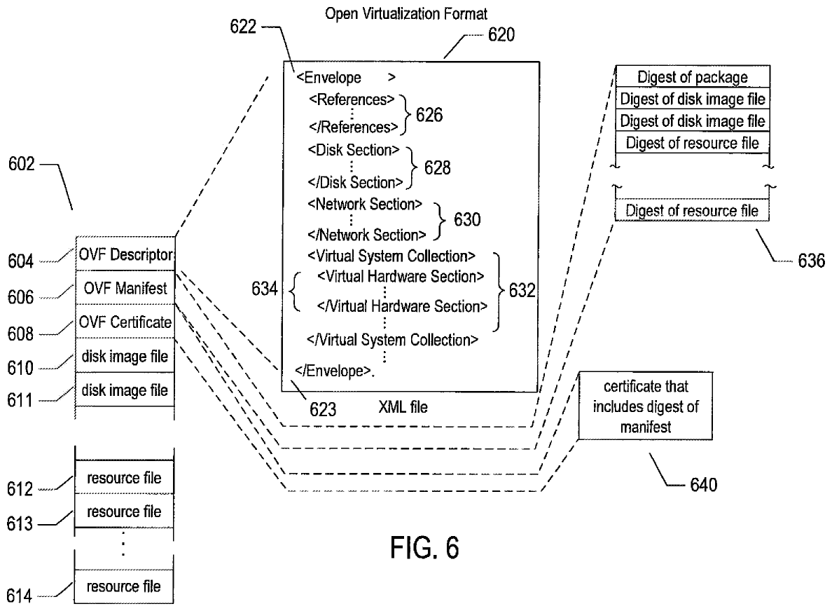

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, include a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

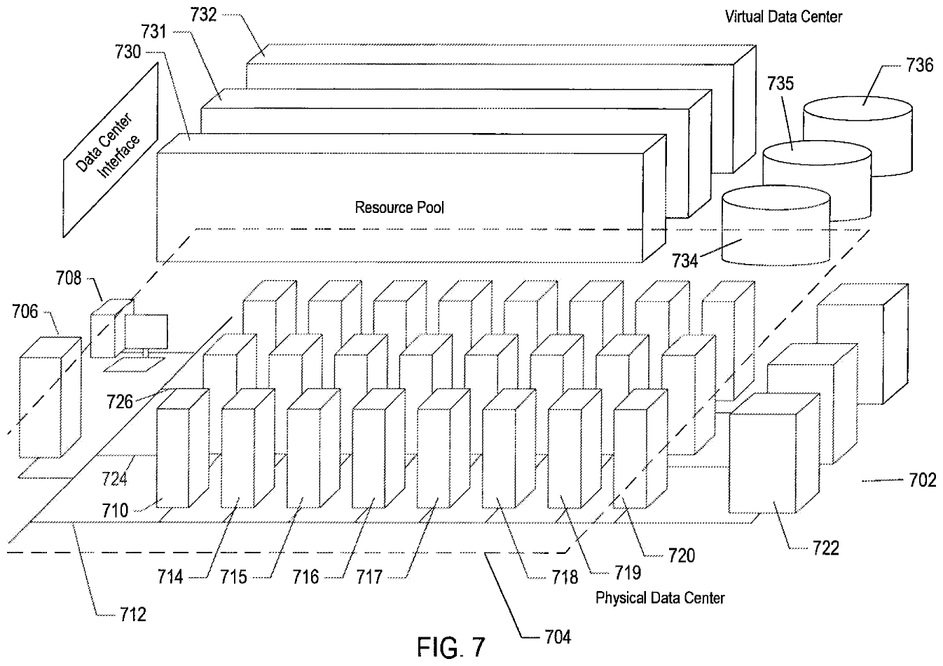

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

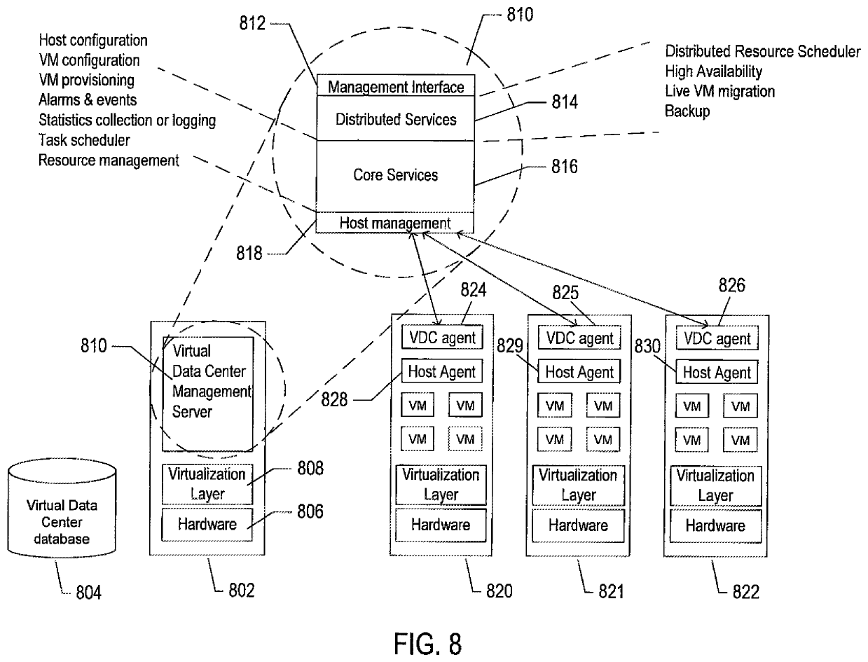

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

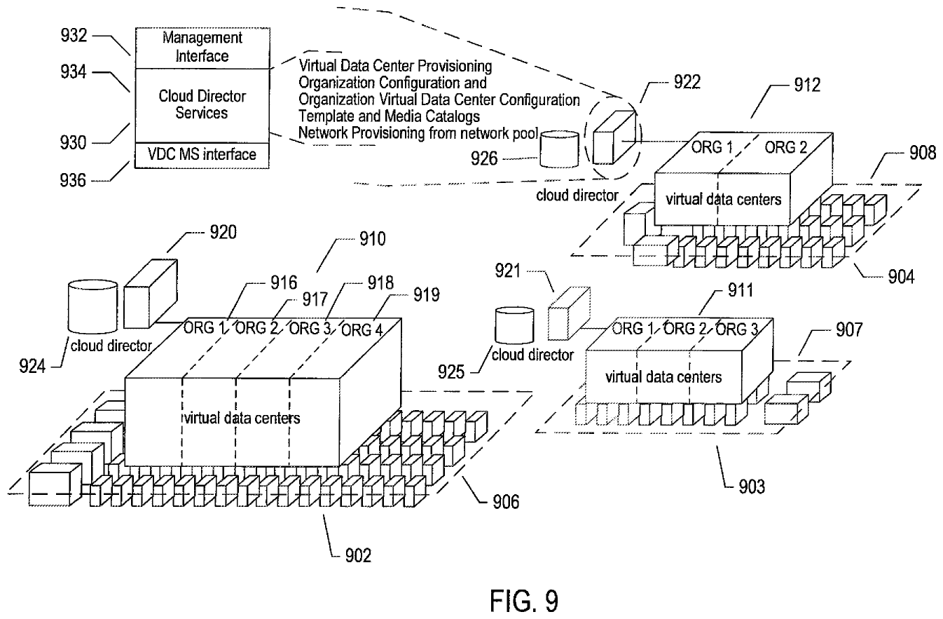

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ m VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous, distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. A container is an abstraction at the application layer that packages code and dependencies together. Multiple containers can run on the same computer system and share the operating system kernel, each container running as an isolated process in the user space. One or more containers are run in pods. For example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. The containers are isolated from one another and bundle their own software, libraries, and configuration files within in the pods. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

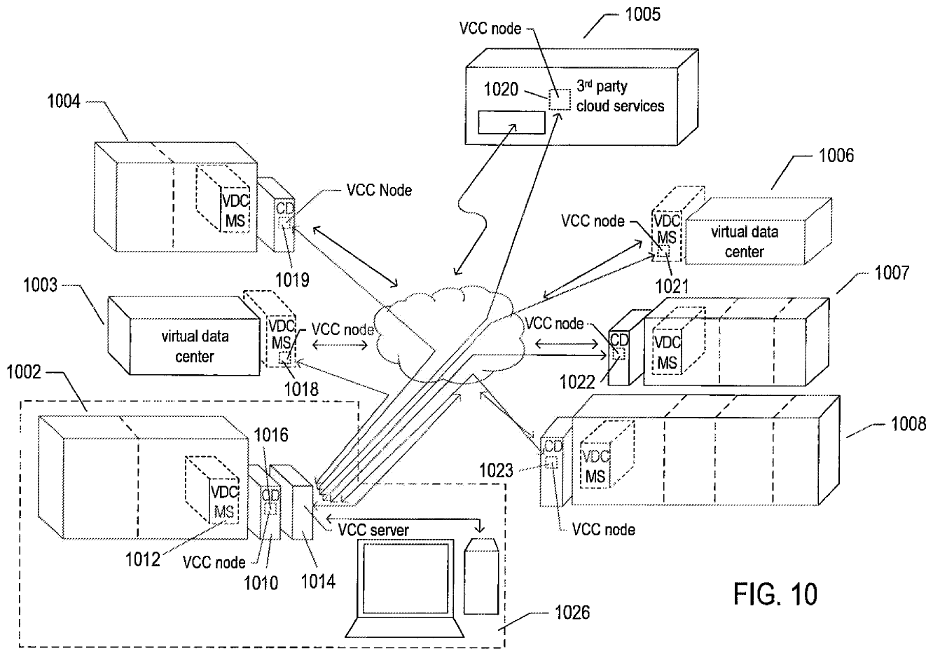

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

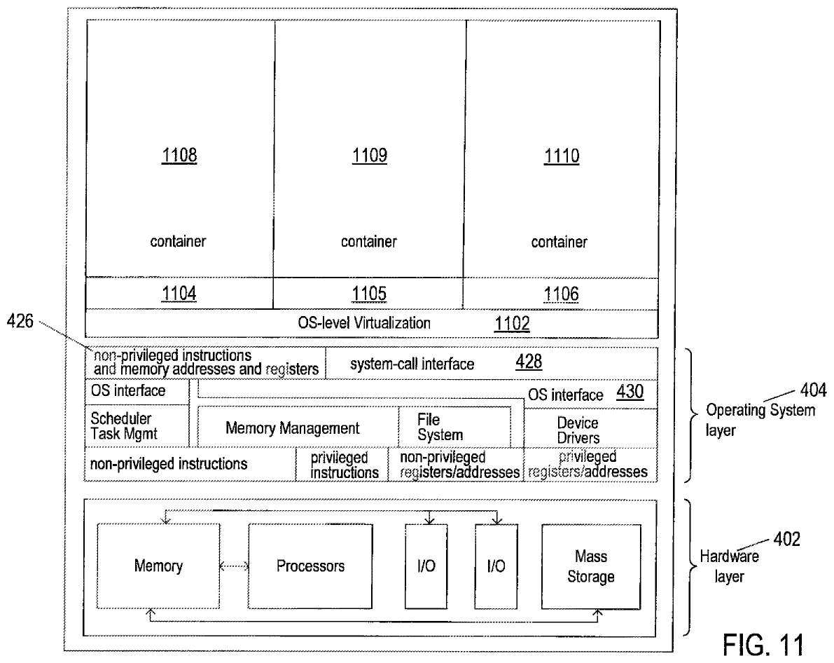

FIG. 12 shows an approach to implementing the containers in a VM. FIG. 12 shows a host computer similar to that shown in FIG. 5A, discussed above. The host computer includes a hardware layer 502 and a virtualization layer 504 that provides a virtual hardware interface 508 to a guest operating system 1202. Unlike in FIG. 5A, the guest operating system interfaces to an OSL-virtualization layer 1204 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at runtime between containers. The traditional virtualization layer provides for flexible and scaling over large numbers of hosts within large, distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Cloud Infrastructure and Operations Manager

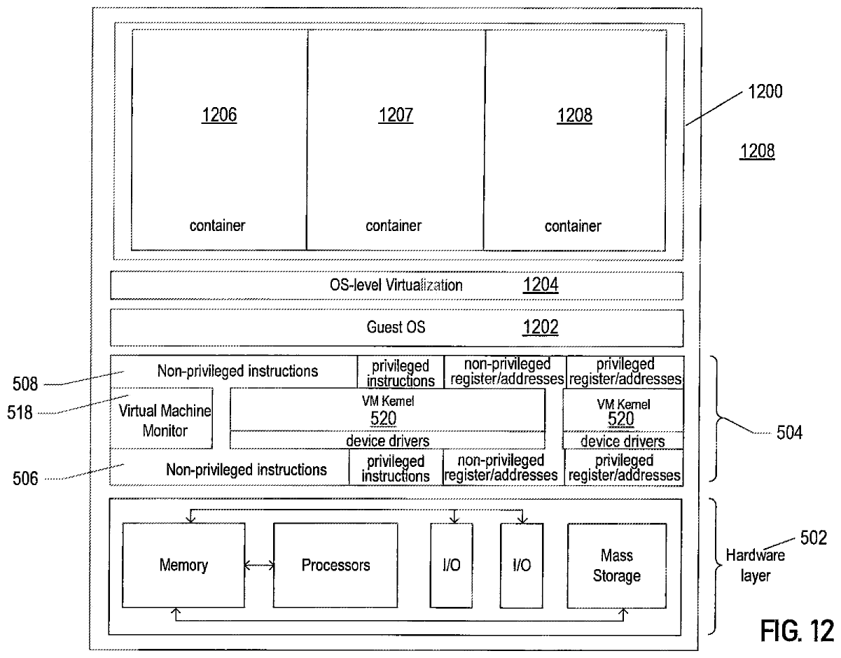

FIG. 13 shows an example of a cloud infrastructure composed of a virtualization layer 1302 located above a physical data center 1304. For the sake of illustration, the virtualization layer 1302 is separated from the data center 1304 by a virtual-interface plane 1306. The data center 1304 is an example of a distributed computing system. The data center 1304 comprises physical objects, including an administration computer system 1308, any of various computers, such as PC 1310, on which a virtual data center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers are networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects executing in the virtualization layer 1302.

The virtual-interface plane 1306 abstracts the resources of the physical data center 1304 to one or more VDCs comprising the virtual objects and one or more virtual data stores, such as virtual data store 1328. For example, one VDC may comprise the VMs running on server computer 1324 and virtual data store 1328. The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and NICs formed from the physical switches, routers, and NICs of the physical data center 1304. Certain server computers host VMs and containers as described above. For example, server computer 1318 hosts two containers identified as Cont₁ and Cont₂; cluster of server computers 1312-1314 host six VMs identified as VM₁, VM₂, VM₃, VM₄, VM₅, and VM₆; server computer 1324 hosts four VMs identified as VM₇, VM₈, VM₉, VM₁₀. Other server computers may host standalone applications as described above with reference to FIG. 4. For example, server computer 1326 hosts applications App₁, App₂, App₃, and App₄.

For the sake of illustration, the data center 1304 and virtualization layer 1302 are shown with a small number of objects. In practice, a typical data center runs thousands of server computers that are used to run thousands of VMs and containers. Different data centers may include many different types of computers, networks, data-storage systems, and devices connected according to many different types of connection topologies described below.

Computer-implemented methods described herein are performed by an operations management server 1330 that is executed on the administration computer system 1308. The operations management 1330 runs a recommender system, called a site reliability engineering cloud sweeper (“SRE cloud sweeper”), that identifies individual applications, microservices, and other objects that are idle and waste resources of the cloud infrastructure and terminate the offending objects. For each object running in the cloud infrastructure, the SRE cloud sweeper employs a rule learning engine to train rules for identifying terminated objects and alive objects based on event types of log messages recorded in time intervals when the object was idle and wasting resources of the cloud infrastructure and when the object was alive and actively processing data as intended. In the following discussion, the term “terminated” object refers to an object that was previously idle and terminated, or deleted, from the cloud infrastructure and the term “alive” object refers to an object that actively processes data and is not wasting cloud infrastructure resources. The rules for detecting terminated objects are verified by domain experts, such as site reliability engineering terms, and can be modified to improve detection of the object in an idle or alive state. The SRE cloud sweeper uses the rules to detect current idle objects based the frequencies of event types of recently generated log messages and terminates the current idle objects identified as idle objects, thereby freeing wasted resources for assignment to other applications, microservices, and other objects of the cloud infrastructure. The SRE cloud sweeper continues to receive log messages of the object and uses the frequencies of event types of the log messages to update the rules with verification from domain experts to refine and confirm the accuracy of the rules.

### Log Messages and Extraction of Event Types

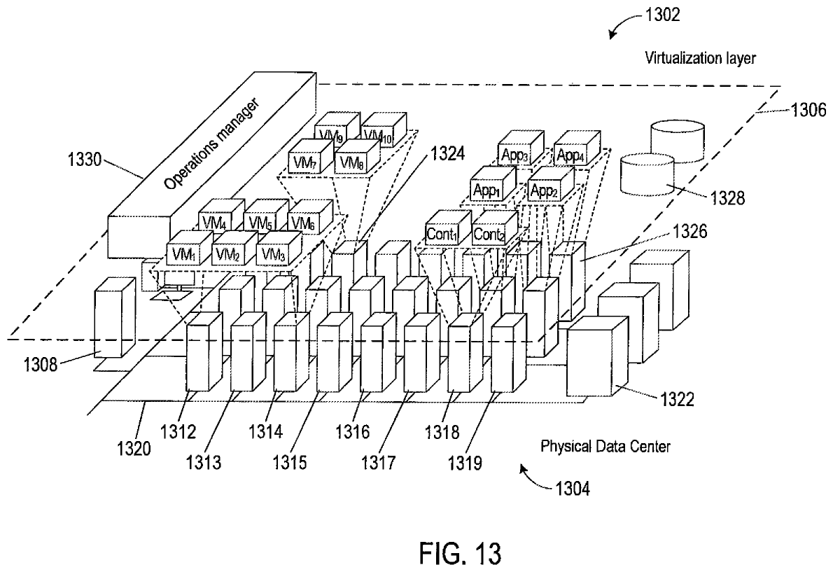

FIG. 14 shows an example of logging log messages in log files. In FIG. 14, computer systems 1312-1316 of the distributed computing system in FIG. 13 are linked together by the electronic communications medium 1320 and additionally linked through a communications bridge/router 1402 to the administration computer system 1308 that includes an administrative console 1404. Each of the computer systems 1312-1316 runs an OTL library and an OTL agent with a corresponding microservice as described above. The OTL agents forward log messages to the operations manager 1330 executing on the administration computer system 1308. As indicated by curved arrows, such as curved arrow 1406, multiple components within each of the discrete computer systems 1312-1316 as well as the communications bridge/router 1402 generate log messages that are forwarded to the operations manager 1330. Log messages may be generated by any event source. Event sources may be, but are not limited to, applications, microservices, operating systems, VMs, guest operating systems, containers, network devices, machine codes, event channels, and other computer programs or processes running on the computer systems 1312-1316, the bridge/router 1402 and any other components of a data center. Log messages may be received by OTL agents at various hierarchical levels within a discrete computer system and then forwarded to the forwarder in the operations manager 1330 executing in the administration computer system 1308. The operations manager 1330 records the log messages in a data storage device or appliance 1408 as log files 1410-1414. Rectangles, such as rectangle 1416, represent individual log messages. Each OTL agent has a configuration that includes a log path and a log parser.

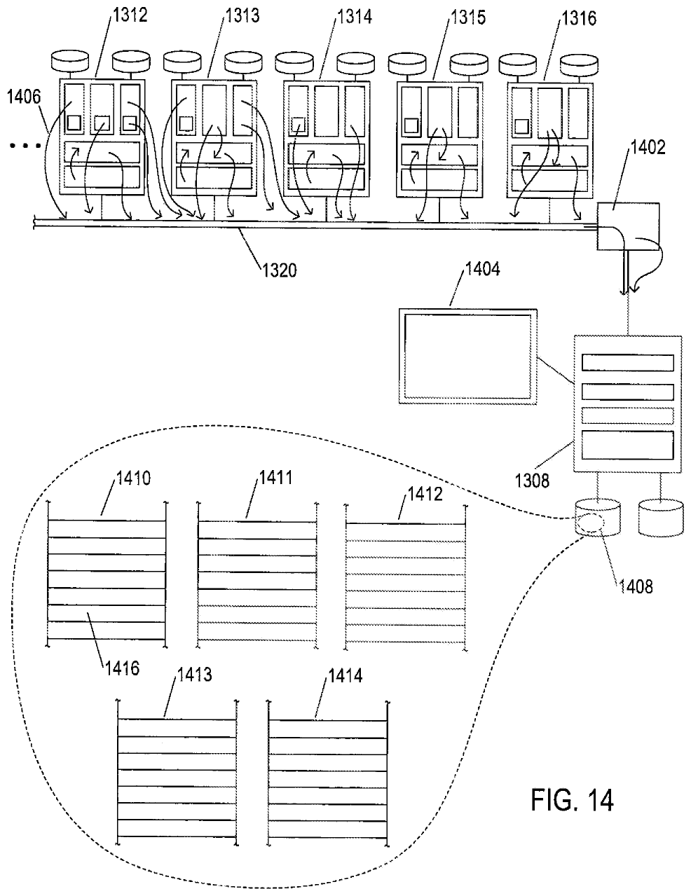

FIG. 15 shows an example source code 1502 of an event source, such as an application, an operating system, a VM, a guest operating system, or any other computer program or machine code that generates log messages. The source code 1502 is just one example of an event source that generates log messages. Rectangles, such as rectangle 1504, represent a definition, a comment, a statement, or a computer instruction that expresses some action to be executed by a computer. The source code 1502 includes log write instructions that generate log messages when certain events predetermined by a developer occur during execution of the source code 1502. For example, the source code 1502 includes an example log write instruction 1506 that when executed generates a “log message 1” 1508, and a second example log write instruction 1510 that when executed generates “log message 2” 1512. In the example of FIG. 15, the log write instruction 1508 is embedded within a set of computer instructions that are repeatedly executed in a loop 1514. As shown in FIG. 15, the same log message 1 is repeatedly generated 1516. The same type of log write instructions may also be located in different places throughout the source code, which in turn creates repeats of essentially the same type of event recorded in multiple log messages in the log file.

In FIG. 15, the notation “log.write( )” is a general representation of a log write instruction. In practice, the form of the log write instruction varies for different programming languages. In general, the log write instructions are determined by the developer. Log write instructions are unstructured, or semi-structured, and relatively cryptic. For example, log write instructions may include instructions for time stamping the log message and contain a message comprising natural-language words and/or phrases as well as various types of text strings that represent file names, path names, and perhaps various alphanumeric parameters that may identify objects, such as VMs, containers, or virtual network interfaces. In practice, a log write instruction may also include the name of the source of the log message (e.g., name of the application program, operating system and version, server computer, and network device) and may include the name of the log file to which the log message is recorded. Log write instructions may be written in a source code by the developer of an application program or operating system in order to record the state of the application program or operating system at a point in time and to record events that occur while an operating system or application program is executing. For example, a developer may include log write instructions that record informative events including, but are not limited to, identifying startups, shutdowns, I/O operations of applications or devices; errors identifying runtime deviations from normal behavior or unexpected conditions of applications or non-responsive devices; fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

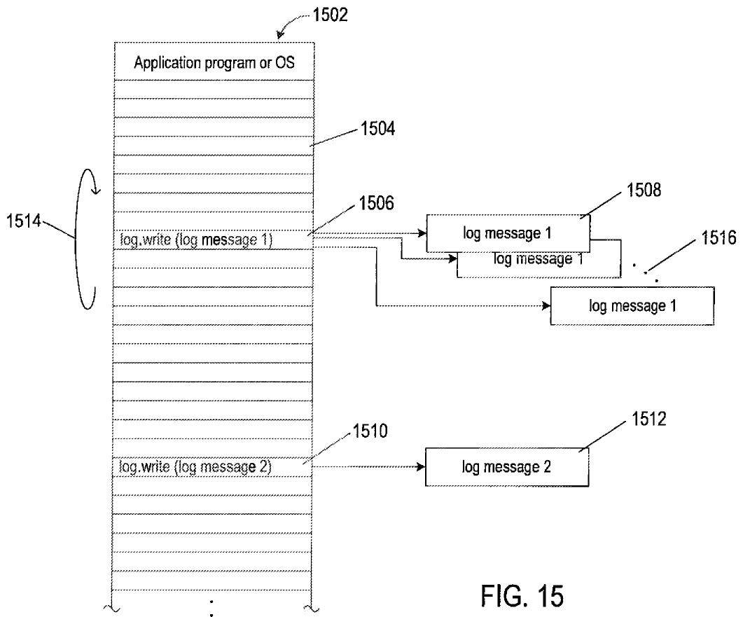

FIG. 16 shows an example of a log write instruction 1602. The log write instruction 1602 includes arguments identified with “$” that are filled at the time the log message is created. For example, the log write instruction 1602 includes a time-stamp argument 1604, a thread number argument 1606, and an internet protocol (“IP”) address argument 1608. The example log write instruction 1602 also includes text strings and natural-language words and phrases that identify the level of importance of the log message and type of event that triggered the log write instruction, such as “Repair session” 1608. The text strings between brackets “[ ]” represent file-system paths, such as path 1610. When the log write instruction 1602 is executed, parameters are assigned to the arguments and the text strings and natural-language words and phrases are stored as a log message in a log file.

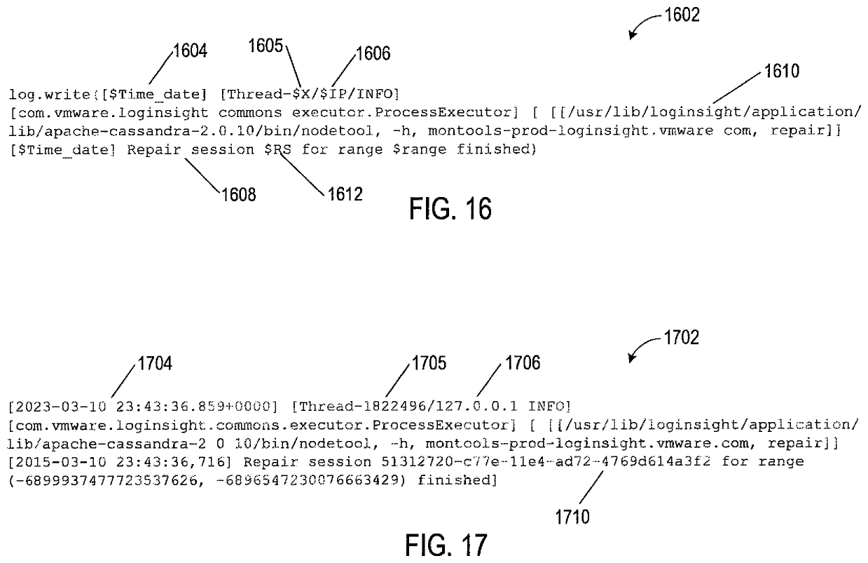

FIG. 17 shows an example of a log message 1702 generated by the log write instruction 1602. The arguments of the log write instruction 1602 are assigned numerical parameters that are recorded in the log message 1702 at the time the log write instruction is executed. For example, the time stamp 1604, thread 1606, and IP address 1608 arguments of the log write instruction 1602 are assigned corresponding numerical parameters 1704, 1706, and 1708 in the log message 1702. The time stamp 1704 represents the date and time the log message is generated. The text strings and natural-language words and phrases of the log write instruction 1602 also appear unchanged in the log message 1702 and are used to identify the type of event (e.g., informative, warning, error, or fatal) that occurred during execution of the event source.

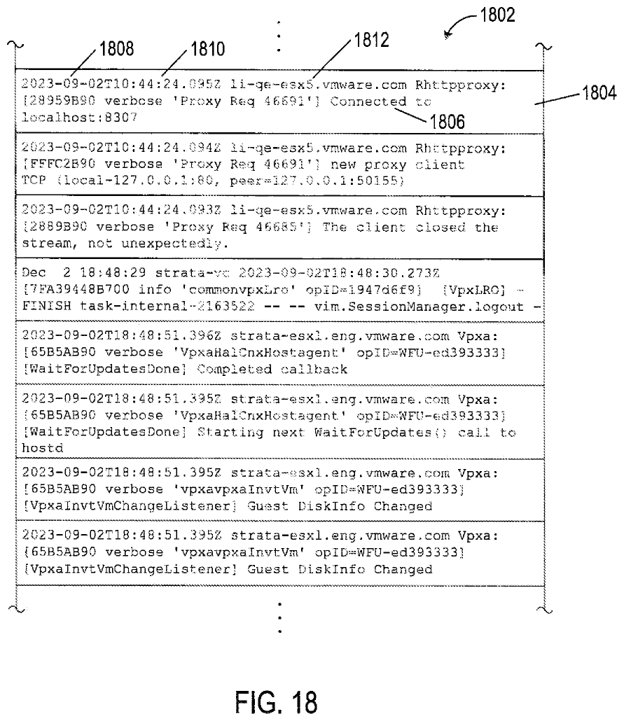

As log messages are received at the operations manager 1330 from various event sources, the log messages are stored in files in the order in which the log messages are received. FIG. 18 shows a small, eight-entry portion of a log file 1802. In FIG. 18, each rectangular cell, such as rectangular cell 1804, of the log file 1802 represents a single stored log message. For example, log message 1804 includes a short natural-language phrase 1806, date 1808 and time 1810 numerical parameters, and an alphanumeric parameter 1812 that identify a particular host computer server.

In one implementation, the operations manager 1330 extracts parametric and non-parametric strings of characters called tokens from log messages using regular expressions. A regular expression, also called “regex,” is a sequence of symbols that defines a search pattern in text data. Many regex symbols match letters and numbers. For example, the regex symbol “a” matches the letter “a,” but not the letter “b,” and the regex symbol “100” matches the number “100,” but not the number 101. The regex symbol “.” matches any character. For example, the regex symbol “.art” matches the words “dart.” “cart,” and “tart,” but does not match the words “art,” “hurt,” and “dark.” A regex followed by an asterisk “*” matches zero or more occurrences of the regex. A regex followed by a plus sign “+” matches one or more occurrences of a one-character regex. A regular expression followed by a questions mark “?” matches zero or one occurrence of a one-character regex. For example, the regex “a*b” matches b, ab, and aaab but does not match “baa.” The regex “a+b” matches ab and aaab but does not match b or baa. Other regex symbols include a “\d” that matches a digit in 0123456789, a “\s” matches a white space, and a “\b” matches a word boundary. A string of characters enclosed by square brackets, [ ], matches any one character in that string. A minus sign “−” within square brackets indicates a range of consecutive ASCII characters. For example, the regex [aeiou] matches any vowel, the regex [a-f] matches a letter in the letters abcdef, the regex [0-9] matches a 0123456789, the regex [._%+−] matches any one of the characters ._%+−. The regex [0-9a-f] matches a number in 0123456789 and a single letter in abcdef. For example, [0-9a-f]matches a6, i5, and u2 but does not match ex, 9v, or %6. Regular expressions separated a vertical bar “|” represent an alternative to match the regex on either side of the bar. For example, the regular expression Get|GetValue|Set|SetValue matches any one of the words: Get, GetValue, Set, or SetValue. The braces “{ }” following square brackets may be used to match more than one character enclosed by the square brackets. For example, the regex [0-9]{2} matches two-digit numbers, such as 14 and 73 but not 043 and 4, and the regex [0-9]{1-2} matches any number between 0 and 99, such as 3 and 58 but not 349.

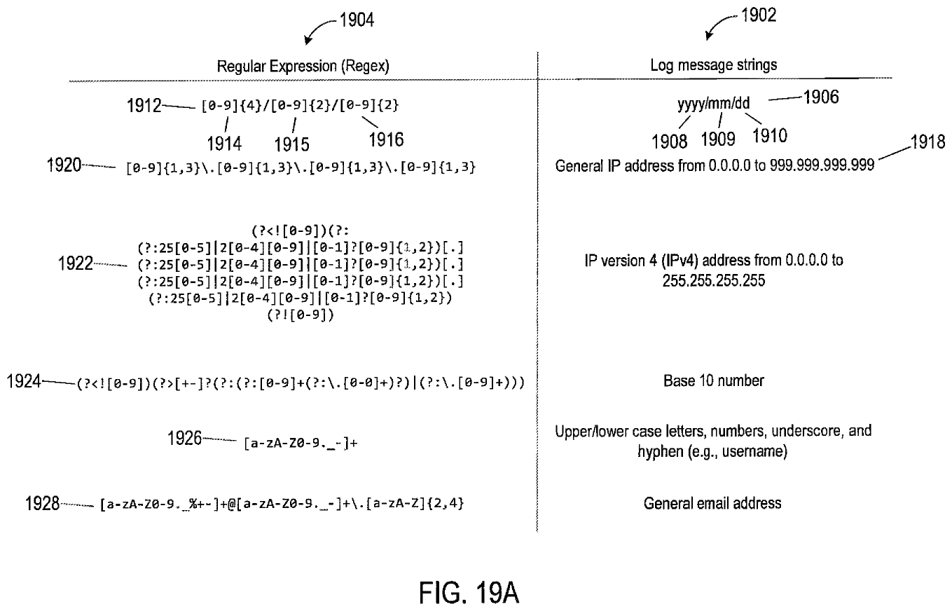

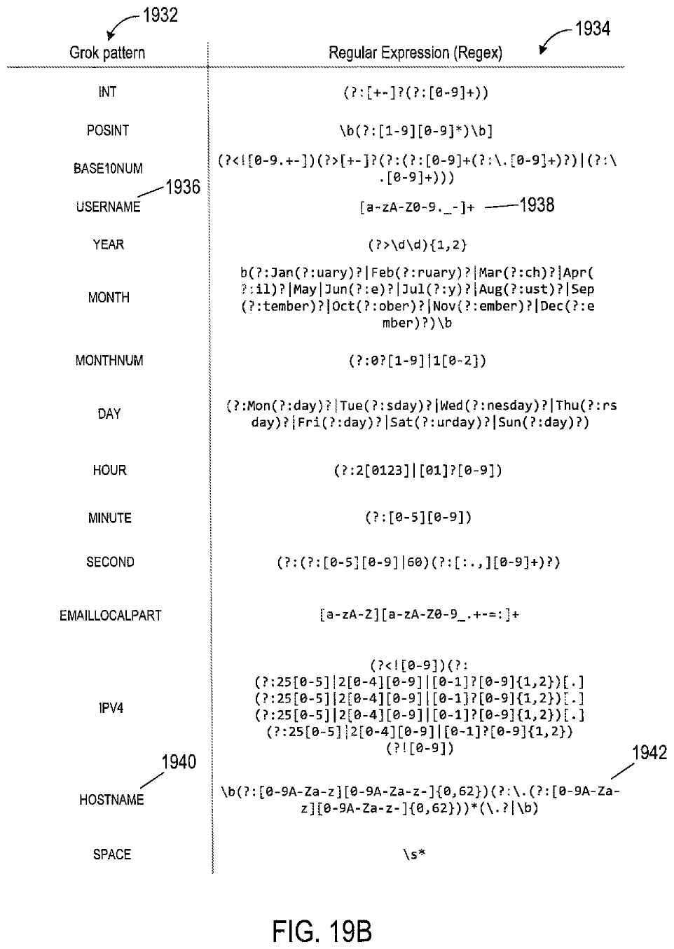

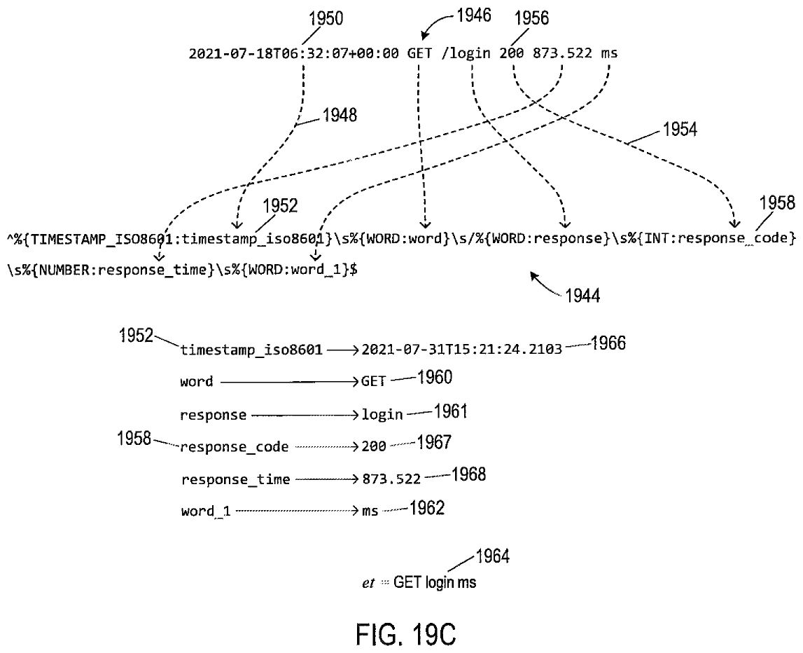

Simple regular expressions are combined to form larger regular expressions that match character strings of log messages and are used to extract the character strings from the log messages. FIG. 19A shown a table of examples of regular expressions designed to match particular character strings of log messages. Column 1902 list six different types of strings that may be found in log messages. Column 1904 list six regular expressions that match the character strings listed in column 1902. For example, entry 1906 of column 1902 represents a format for a date used in the time stamp of many types of log messages. The date is represented with a four-digit year 1908, a two-digit month 1909, and a two-digit day 1910 separated by slashes. The regex 1912 includes regular expressions 1914-1916 separated by slashes. The regular expressions 1914-1916 match the characters used to represent the year 1908, month 1909, and day 1910. Entry 1918 of column 1902 represents a general format for internet protocol (“IP”) addresses. A typical general IP address comprises four numbers. Each number ranges from 0 to 999 and each pair of numbers is separated by a period, such as 27.0.15.123. Regex 1920 in column 1904 matches a general IP address. The regex [0-9]{1-3} matches a number between 0 and 999. The backslash “\” before each period indicates the period is part of the IP address and is different from the regex symbol “.” used to represent any character. Regex 1922 matches any IPv4 address. Regex 1924 matches any base-10 number. Regex 1926 matches one or more occurrences of a lower-case letter, an upper-case letter, a number between 0 and 9, a period, an underscore, and a hyphen in a character string. Regex 1928 matches email addresses. Regex 1928 includes the regex 1926 after the ampersand symbol. Regular expressions are used to extract non-parametric tokens that combine to form the event type of the log message.

In another implementation, the operations manager 1330 extracts non-parametric tokens from log messages using Grok expressions. Grok is a regular expression dialect that supports reusable aliased expressions. Grok patterns are predefined symbolic representations of regular expressions that reduce the complexity of constructing regular expressions. Grok patterns are categorized as either primary Grok patterns or composite Grok patterns that are formed from primary Grok patterns. A Grok pattern is called and executed using the notation Grok syntax %{SYNTAX}.

FIG. 19B shows a table of examples of primary Grok patterns and corresponding regular expressions. Column 1932 contains a list of primary Grok patterns. Column 1934 contains a list of regular expressions represented by the Grok patterns in column 1932. For example, the Grok pattern “USERNAME” 1936 represents the regex 1938 that matches one or more occurrences of a lower-case letter, an upper-case letter, a number between 0 and 9, a period, an underscore, and a hyphen in a character string. Grok pattern “HOSTNAME” 1940 represents the regex 1942 that matches a hostname. A hostname comprises a sequence of labels that are concatenated with periods. Note that the list of primary Grok patterns shown in FIG. 19B is not an exhaustive list of primary Grok patterns.

Grok patterns may be used to map specific character strings into dedicated variable identifiers. The syntax for using a Grok pattern to map a character string to a variable identifier is given by:
%{GROK_PATTERN:variable_name}
where
GROK_PATTERN represents a primary or a composite Grok pattern; and
variable_name is a variable identifier assigned to a character string in text data that matches the GROK_PATTERN.
   A Grok expression is a parsing expression that is constructed from Grok patterns that match characters strings in text data and are used to parse character strings of a log message. Consider, for example, the following simple example segment of a log message:
34.5.243.1 GET index.html 14763 0.064
   A Grok expression that may be used to parse the example segment is given by:

\hat{ }%{IP:ip_address}\s%{WORD:word}\s%{URIPATHPARAM:request}\s
%{INT:bytes}\s%{NUMBER:duration}$

The hat symbol “\hat{ }” identifies the beginning of a Grok expression. The dollar sign symbol “S” identifies the end of a Grok expression. The symbol “\s” matches spaces between character strings in the example segment. The Grok expression parses the example segment by assigning the character strings of the log message to the variable identifiers of the Grok expression as follows:
ip_address: 34.5.243.1
word: GET
request: index.html
bytes: 14763
duration: 0.064

Different types of regular expressions and Grok expressions are constructed to match token patterns of log messages and extract non-parametric tokens from the log messages. Numerous log messages may have different parametric tokens but the same set of non-parametric tokens. The non-parametric tokens extracted from a log message describe the type of event, or event type, recorded in the log message. The event type of a log message is denoted by etₙ, where subscript n is an index that distinguishes the different event types of log messages.

FIG. 19C shows an example of a Grok expression 1944 used to extract tokens from a log message 1946. Dashed directional arrows represent parsing the log message 1946 such that tokens that correspond to Grok patterns of the Grok expression 1944 are assigned to corresponding variable identifiers. For example, dashed directional arrow 1948 represents assigning the time stamp 2021-07-18T06:32:07+00:00 1950 to the variable identifier timestamp_iso86011 952 and dashed directional arrow 954 represents assigning HTTP response code 200 1956 to the variable identifier response_code 1958. FIG. 19C shows assignments of tokens of the log message 1946 to variable identifiers of the Grok expression 1944. The combination of non-parametric tokens 1960-1962 identify the event type 1964 of the log message 1946. Parametric tokens 1966-1968 may change for different log messages with the same event type 1964.

### Computer-Implemented Methods and Systems for Detecting and Terminating Idle Objects in a Cloud Infrastructure

The operations manager 1330 computes a frequency distribution of event types of log messages produced in a time interval for an object executing in a cloud infrastructure. Let N be the total number of event types that can be extracted from log messages generated by event sources associated with the object. The length of the time interval can be a few hours, a few days, a few weeks, or a month, depending on the object. The operations manager 1330 computes the number of times each event type appeared in the time interval. Let cₙ denote an event type counter of the number of times the event type etₙ occurred in the time interval, where n=1, . . . , N. The operations manager 1330 normalizes the count of each event type to obtain a corresponding event type frequency given by:

$${f}_{n} = \frac{{c}_{n}}{K} \qquad ( 1 )$$

where K is the number of log messages generated in the time interval.
   The operations manager 1330 forms a frequency distribution of the event types occurring in the time interval:

$$F = ( {f}_{1} , {f}_{2} , … , f , … , {f}_{N - 1} , {f}_{N} ) \qquad ( 2 )$$

The frequency distribution contains the frequencies of all possible event types associated with an object. Note that certain event types may not occur in the time interval. In these cases, fₙ=0 (i.e., cₙ=0). In other words, the frequency distribution is like a fingerprint of the types of events that occur when the object is idle.

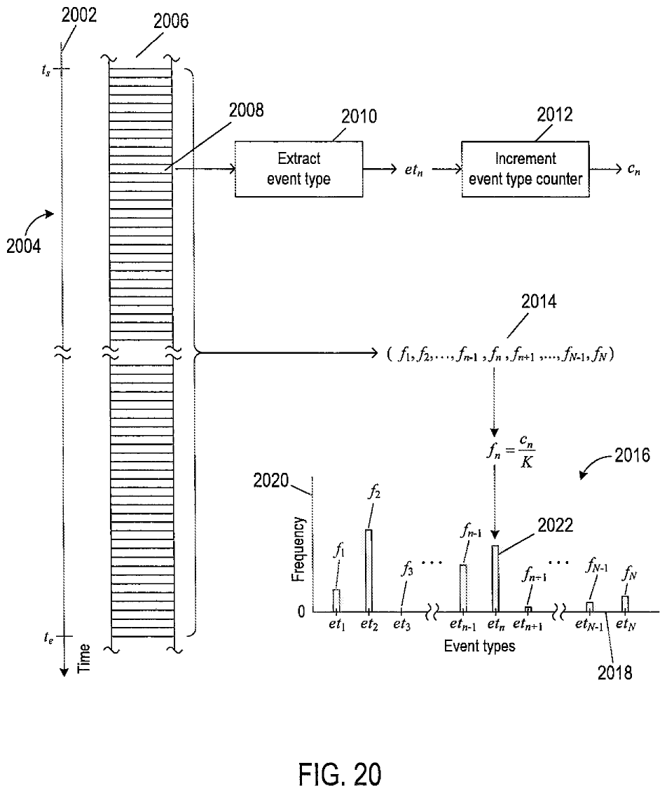

FIG. 20 shows construction of example frequency distribution from log messages of an object produced in a time interval when the object was idle. FIG. 20 shows a time axis 2002 and time interval [tₛ,tₑ] 2004. FIG. 20 also shows a portion of a log file 2006 that contains log messages with time stamps in the time interval [tₛ,tₑ]2004. Each log message in the log file 2006 is represented by a rectangle. For example, rectangle 2008 represents a log message with a time stamp in the time interval 2004. In block 2010, an event type is extracted from each log message in the time interval 2004 using a corresponding Regex or Grok expression as described above with reference to FIGS. 19A-19C. In block 2012, the operations manager 1330 computes a count, cₙ, of event type, etₙ, extracted from the log messages. The operations manager 1330 normalizes the counts to obtain corresponding frequencies and forms a frequency distribution from the event types in the time intervals. Frequency distribution 2014 represents the relative frequencies of the event types occurring in the time interval 2004. FIG. 20 shows an example plot 2016 of frequencies of a frequency distribution 2014. The horizontal axis 2018 represents the range of all possible event types associated with the object. The vertical axis 2020 represents the range of frequencies. Bars represent the frequencies of different event types. For example, bar 2022 represents the value of the frequency fₙ of the event type etₙ occurring in the time interval 2004. The frequency distribution 2016 includes zero frequencies that correspond to event types that did not occur in the time interval 2004. For example, the frequency f₃ of the event type et₃ is zero because log messages with the event type et₃ were not generated in the time interval 2004.

The operations manager 1330 computes a frequency distribution of event types as described above for previous time intervals when the object was idle and terminated by domain experts and when the object was alive and executing processes. The operations manager 1330 forms a data frame from the frequency distributions and identifies the event types non-zero frequencies and are common to each of the frequency distributions. The operations manager 1330 also computes a frequency distribution event types as described above for a current time interval so that rules determined as described below can be used to determine whether the object is currently idle or alive and actively; processing data as part of a service.

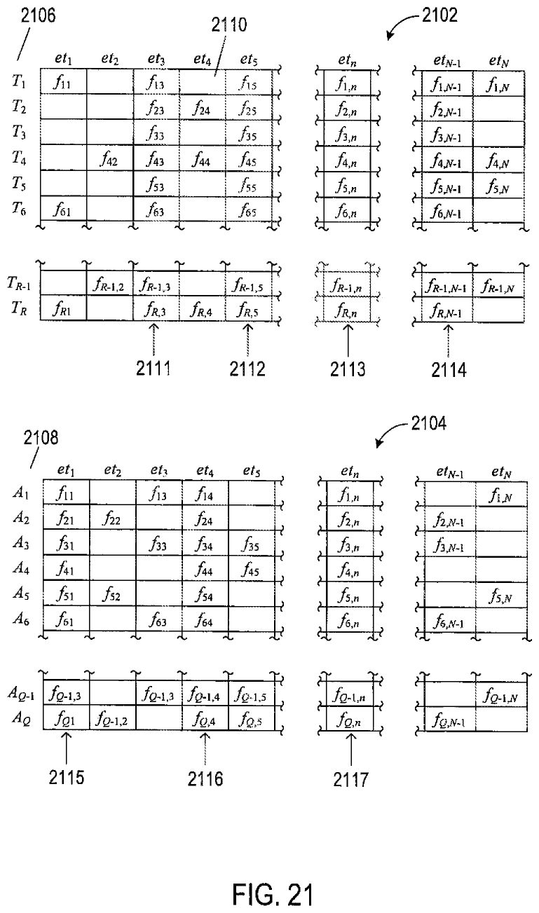

FIG. 21 shows an example data frame 2102 obtained for R separate termination instances of the object and an example data frame 2104 obtained for Q separate alive instances of the object. The termination instances are denoted by Tᵣ and listed in column 2106, where r=1, . . . , R, of the data frame 2102. The alive instances are denoted by A_{q} and listed in column 2108, where q=1, . . . , Q. of the data frame 2104. Each row represents frequencies of the event types associated with the object in one of the R termination instances or one of the alive instances. A blank entry, such as entry 2110, represents a zero frequency for a corresponding event type. In this example, columns 2111-2114 contain non-zero frequencies that are common to the R termination instances of the object. Columns 2115-2117 contain non-zero frequencies that are common to the Q alive instances of the object. Note that terminated instances and alive instances may have event types in common. For example, the terminated instances and the alive instances have in common the event type etₙ.

The non-zero frequencies that are common to the R termination instances and Q alive instance of the object are input to a rule learning engine. The rule learning engine outputs rules for identifying idle and alive instances of the object. The rules are evaluated by domain experts and may be adjusted by the domain experts via a graphical user interface (“GUI”) displayed on a display device. The final rules approved domain experts are in turn used to detect when the object is idle and wasting resources based on frequencies of the event types of current log messages associated with the object. The rule learning engine can be a machine learning rule-based classification algorithm, such as repeated increment pruning to produce error reduction (“RIPPER”), or a decision-tree learning classification algorithm, such as ID3, C4.5, or C5.0.

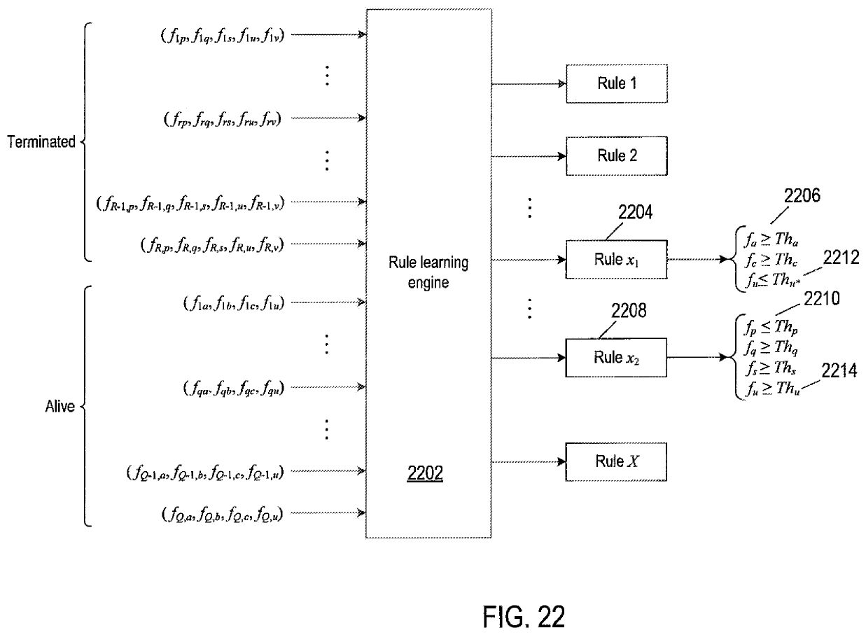

FIG. 22 shows an example rule learning engine used to generate rules for frequencies of common event types of the object. Block 2202 represents a rule learning engine that receives as input frequencies of common event types for the R termination instances and Q alive instances of the object. In this example, the frequencies of five event types denoted by etₚ, et_{q}, etₛ, etᵤ, and etᵥ that are common to log messages of the object for the R termination instances are denoted by fᵣₚ, f_{rq}, fᵣₛ, fᵣᵤ, and fᵣᵥ, where subscript r=1, . . . , R. The frequencies of four event types denoted by etₐ, et_{b}, et_{c}, and etᵤ that are common to log messages of the object for the Q alive instances are denoted by f_{qa}, f_{qb}, f_{qc}, and f_{qu}, where subscript q=1, . . . , Q. Note that the terminated and alive instances have the event type etᵤ in common. The rule learning engine 2202 generates X rules denoted by Rule x, where x=1, . . . , X, for detecting terminated and alive instances of the object. Each rule is composed of one or more conditions. Each condition relates a frequency of an event type to a threshold, such as fₙ≥Thₙ or fₙ≤Thₙ, where Thₙ denotes the threshold for the condition. For example, Rule x₁ 2204 is composed of three conditions 2206 for identifying the object in an alive instance. Rule x₂ 2208 is composed of four conditions 2210 for identifying the object in an idle instance. Note that rules Rule x₁ 2204 and Rule x₂ 2208 have in common different conditions 2212 and 2214, respectively, for the frequency fᵤ of the event type etᵤ. The conditions 2212 and 2214 have different thresholds Thᵤ, and Thᵤ for detection idle and alive instances of the object.

After a set of rules are generated by the rule learning engine 2202, the rules are validated by domain experts. The operations manager 1330 displays the rules and corresponding conditions in a graphical user interface (“GUI”) that enables domain experts to verify the event types and the corresponding frequency distribution. The GUI enables a domain expert to enrich the rules by removing certain conditions and/or adding other conditions that were not extracted by the rule learning engine 2202 based on the domain experts knowledge and experience.

The operations manager 1330 also maintains a confidence record for each of the rules. Each rule has a corresponding confidence based on previous use of the rule in detecting when the object is idle. The confidence is composed displayed as a fraction in the GUI. The numerator of the confidence is a count of the total number of times the rule has been used to detect idle instances for the object and the object has been terminated. The denominator of the confidence is a count of the number of misclassified idle instances. The domain expert can use the confidence to assess reliability of the conditions that form the rule.

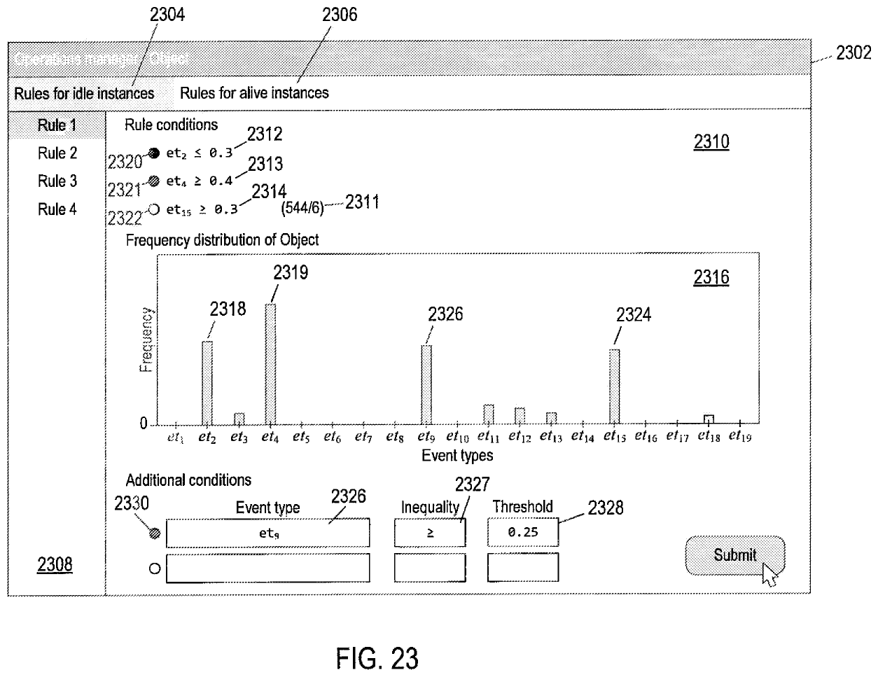

FIG. 23 shows an example GUI 2302 that enables a domain expert to view and validate rules for detecting idle instances and alive instances of an object running in a cloud infrastructure. The object can be a microservice of a distributed application or the object can be a monolithic application. The GUI 2302 displays a tab 2304 for selecting “rules for idle instances” and a tab 2306 for selecting “rules for alive instances.” In this example, the user has selected the “rules for idle instances” tab 2304. The rules for detecting idle instances of the application are displayed in pane 2308. The domain expert has selected Rule 1. The conditions for Rule 1 and confidence 2311 are displayed in pane 2310. Rule 1 is composed of three conditions 2312-2314. The confidence 2311 indicates that the conditions 2312-2314 of Rule 1 have been used to terminate the object 544 times and of those terminations 6 were misclassified. In other words, Rule 1 has a confidence of 98.9%. The pane 2310 also displays a plot 2316 of the frequency distribution for the object that was input to the rule learning engine 2202 so that the domain expert can check for other event types that may have been omitted by the rule learning engine 2202 during generation of the rules. The plot 2316 enables the domain expert to verify that the frequencies 2318 and 2319 of the corresponding event types et₂ and et₄ are large and indicative of the object being idle. The domain expert approves the conditions 2312 and 2313 by clicking on the buttons 2320 and 2321. Note that the domain expert has not clicked on the button 2322 because the domain expert has determined from experience that, although the corresponding event type et₁₅ has a significant corresponding frequency 2324, the event type et₁₅ itself is not a reliable indicator of an idle object. As a result, by not clicking on the button 2322, the condition 2314 is not added to Rule 1. The GUI 2302 includes fields, such as fields 2326-2328, that enable the domain expert to enrich Rule 1 by adding other conditions. For example, the domain expert has noticed that in plot 2316 the frequency 2326 for the event type et₉ is significant and that, although the rule learning engine 2202 missed including a condition for the event type et₉ in Rule 1, the domain expert knows from experience that when the frequency of the event type et₉ is significant the object is idle. The domain expert inputs parameters for the event type et₉ into the fields 2316-2328 and clicks on button 2330. When the domain expert clicks on the submit button, Rule 1 composed of the three conditions 2312, 2313, and the condition input to the fields 2326-2328 is stored in a rules database. The domain expert can also change the threshold and/or inequality of a condition by not clicking on the corresponding button under “Rule conditions” and under “Additional conditions” use the fields 2326-2328 to recreate the condition by inputting the event type, threshold and/or inequality of the condition.

The GUI 2302 can also be used to verify rules for detecting and monitoring alive instances of the object by clicking on the tab 2306 for “rules for alive instances.” It is important to validate rules that can detect and monitor alive instances of an object. Rules that detect alive instances of an application can be used to block accidental termination of an alive object by a domain expert.

The ability the GUI 2302 to allow domain experts to view the conditions of a selected rule and add new conditions is important because the rules output from the rule learning engine 2202 may not cover all possible conditions. There might be some scenarios in which domain experts are confident about terminating an object for idleness, but the corresponding rule and conditions were not extracted by the rule learning engine. The validated rules are then stored in a rule database. The rule database is accessed by the operations manager 1330 to detect current idle and alive instances of the object. For example, when frequencies of event types of the object in a current time interval satisfy the conditions of the rule 2204 in FIG. 22, the object is considered alive and is left undisturbed. By contrast, when frequencies of event types of the object in a current time interval satisfy the conditions of the rule 2208, the object is considered idle. The idle object is terminated to free up wasted resources assigned to the object.

Log messages associated with the object are collected in a current or runtime time interval. Event type frequencies of the log generated in the current time interval are determined, as described above with reference to FIG. 20, to form a current frequency distribution of the event types of the object. The non-zero frequencies of the event types occurring in the current time interval are compared with threshold conditions for each of the verified rules to determine whether or not the object is currently idle. When a subset of the non-zero frequencies matches all of the conditions of a rule the object is identified as idle and may be automatically terminated by deleting the object from the cloud infrastructure, thereby freeing up the resources wasted by the object for use by other objects executing in the cloud infrastructure. Alternatively, when a subset of the non-zero frequencies matches all of the conditions of a rule that indicates the object as idle, the non-zero frequencies may be compared with the rules for determining whether the object is alive. If a subset of the non-zero frequencies also satisfies all of the conditions of a rule that identifies the object as alive, an alert is triggered and displayed on a system console. A domain expert can then check to resolve the conflict and terminate the object if the rule for identifying an alive object is not accurate.

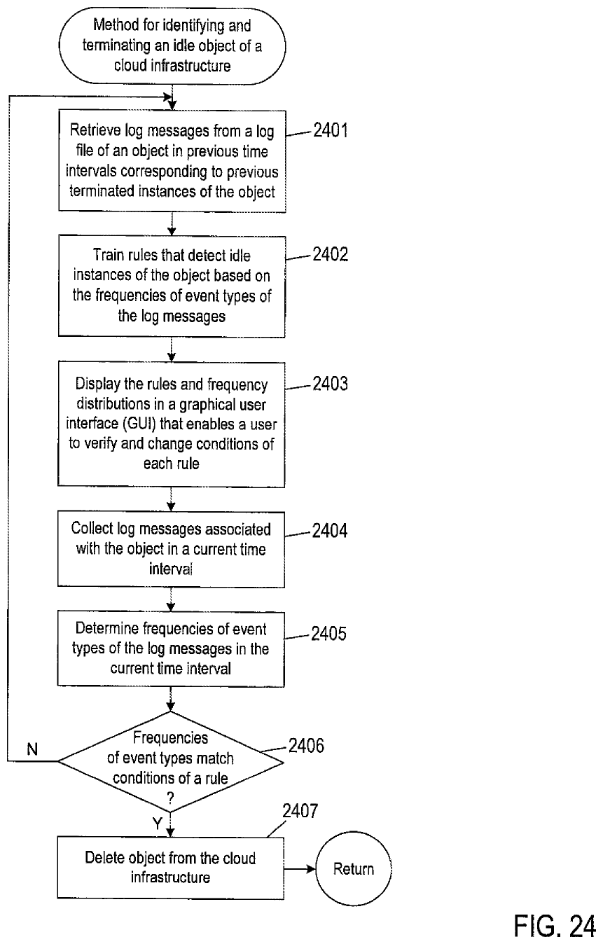

FIG. 24 is a flow diagram of a method for detecting and terminating an idle object executing in a cloud infrastructure. In block 2401, retrieve log messages stored in a log file of the object with time stamps in time intervals that correspond to previous terminated instances of the object. In block 2402, train rules that detect idle instances of the object based on frequencies of event types of the log messages that correspond to the previous terminated instances of the object. In block 2403, display a graphical user interface (“GUI”) that enables a user to verify and change conditions of the rules and store the conditions in a rules database as described above with reference to FIG. 23. In block 2404, log messages associated with the object are collected in a current time interval. In block 2405, determine frequencies of event types of the log messages in current time interval as described above with reference to FIG. 20. In decision block 2406, when frequencies of the event types of the log messages satisfy conditions of a rule stored in the rule database control flows to block 2406. In block 2407, terminate the object in response to frequencies of event types of log messages recorded in a current time interval and satisfy conditions of a rule stored in the rules database.

The process described above with reference to FIG. 24 is stored in one or more data-storage devices as machine-readable instructions and executed by one or more processors of a computer system, such as the computer system shown in FIG. 1.

The computer-implemented methods described above have the advantage of eliminating human errors in detecting alive and idle objects and terminating idle objects to free up wasted resources. The computer-implemented methods also significantly reduce the time for detecting idle objects from days and weeks to minutes and seconds, thereby terminating idle objects and freeing up wasted resources for used by other objects of the cloud infrastructure.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A computer-implemented process that detects and terminates idle objects executing in a cloud infrastructure, the process comprising:
retrieving log messages stored in a log file of the object with time stamps in time intervals that correspond to previous terminated instances of the object;
training rules that detect idle instances of the object based on frequencies of event types of the log messages that correspond to the previous terminated instances of the object;
displaying a graphical user interface (“GUI”) that enables a user to verify and change conditions of the rules and store the conditions in a rules database; and
automatically terminating the object in response to frequencies of event types of log messages recorded in a current time interval and satisfy conditions of a rule stored in the rules database.

2. The process of claim 1 wherein training the rules to detect idle instances of the object comprises:
for each time interval in time intervals that correspond to previous terminated instances of the object,
determining the event type of each log message,
determining the frequency of occurrence of each event type in the time interval, and
forming a frequency distribution of the event types in the time interval from the frequency of occurrence, the frequency distribution corresponding to a terminated instance of the object; and
using a rule learning engine to generate the rules that detect idle instances of the object based on the frequency distributions that corresponding to terminated instances of the object.

3. The process of claim 1 further comprising:
retrieving log messages stored in a log file of the object with time stamps in time intervals that correspond to previous alive instances of the object; and
training rules that detect alive instances of the object based on frequencies of event types of the log messages that correspond to the previous alive instances of the object.

4. The process of claim 1 wherein displaying the GUI comprises:
for each rule,
displaying one or more conditions of the rule in the GUI;
terminating one or more conditions of the rule selected for deletion by a user via the GUI; and
adding one or more conditions created by the user to the rule via the GUI.

5. A computer system for detecting and terminating idle objects executing in a cloud infrastructure, the computer system comprising:
a display screen;
one or more processors;
one or more data-storage devices; and
machine-readable instructions stored in the one or more data-storage devices that when executed using the one or more processors control the system to perform operations comprising:
retrieving log messages stored in a log file of the object with time stamps in time intervals that correspond to previous terminated instances of the object;
training rules that detect idle instances of the object based on frequencies of event types of the log messages that correspond to the previous terminated instances of the object;
displaying a graphical user interface (“GUI”) that enables a user to verify and change conditions of the rules and store the conditions in a rules database; and
automatically terminating the object in response to frequencies of event types of log messages recorded in a current time interval and satisfy conditions of a rule stored in the rules database.

6. The computer system of claim 6 wherein training the rules to detect idle instances of the object comprises:
for each time interval in time intervals that correspond to previous terminated instances of the object,
determining the event type of each log message,
determining the frequency of occurrence of each event type in the time interval, and
forming a frequency distribution of the event types in the time interval from the frequency of occurrence, the frequency distribution corresponding to a terminated instance of the object; and
using a rule learning engine to generate the rules that detect idle instances of the object based on the frequency distributions that corresponding to terminated instances of the object.

7. The computer system of claim 6 further comprising:
retrieving log messages stored in a log file of the object with time stamps in time intervals that correspond to previous alive instances of the object; and
training rules that detect alive instances of the object based on frequencies of event types of the log messages that correspond to the previous alive instances of the object.

8. The computer system of claim 6 wherein displaying the GUI comprises:
for each rule,
displaying one or more conditions of the rule in the GUI;
terminating one or more conditions of the rule selected for deletion by a user via the GUI; and
adding one or more conditions created by the user to the rule via the GUI.

9. A non-transitory computer-readable medium having instructions encoded thereon for enabling one or more processors of a computer system to perform operations comprising:
retrieving log messages stored in a log file of the object with time stamps in time intervals that correspond to previous terminated instances of the object;
training rules that detect idle instances of the object based on frequencies of event types of the log messages that correspond to the previous terminated instances of the object;
displaying a graphical user interface (“GUI”) that enables a user to verify and change conditions of the rules and store the conditions in a rules database; and
automatically terminating the object in response to frequencies of event types of log messages recorded in a current time interval and satisfy conditions of a rule stored in the rules database.

10. The medium of claim 9 wherein training the rules to detect idle instances of the object comprises:
for each time interval in time intervals that correspond to previous terminated instances of the object,
determining the event type of each log message,
determining the frequency of occurrence of each event type in the time interval, and
forming a frequency distribution of the event types in the time interval from the frequency of occurrence, the frequency distribution corresponding to a terminated instance of the object; and
using a rule learning engine to generate the rules that detect idle instances of the object based on the frequency distributions that corresponding to terminated instances of the object.

11. The medium of claim 9 further comprising:
retrieving log messages stored in a log file of the object with time stamps in time intervals that correspond to previous alive instances of the object; and
training rules that detect alive instances of the object based on frequencies of event types of the log messages that correspond to the previous alive instances of the object.

12. The medium of claim 9 wherein displaying the GUI comprises:
for each rule,
displaying one or more conditions of the rule in the GUI;
terminating one or more conditions of the rule selected for deletion by a user via the GUI; and
adding one or more conditions created by the user to the rule via the GUI.
